(19) United States
(12) Patent Application Publication
(10) Pub. No.: US 2004/0164741 A1
(43) Pub. Date: Aug. 26, 2004

(54) Apparatus for detecting batteries in an uninterruptible power supply by utilizing voltage drop rate

(76) Inventors: Chi-Yi Wang, Miaoli (TW); Wen-Cheng Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/372,142

(22) Filed: Feb. 25, 2003

(51) Int. Cl. G01N 27/416

(52) U.S. Cl. 324/426

(57) ABSTRACT

In order to maintain normal states of machines during cutoff of electric power, an uninterruptible power supply (UPS) is required for a short time before a power generator starts to send out electric power. For normal functioning of a UPS, it is necessary to periodically detect the state of each battery thereof. In addition to measuring the variation of voltage and current of a battery by using a microprocessor, a sensor, and an analog-to-digital converter (ADC), the variation of voltage versus time (i.e., the voltage drop rate) of the battery during discharge is also measured. In other words, the voltage drop rate of a battery is measured as a standard for determining whether the battery is applicable to the UPS.

### FIELD OF THE INVENTION

The present invention relates to an apparatus for detecting batteries in an uninterruptible power supply by utilizing voltage drop rate.

### BACKGROUND OF THE INVENTION

Usually, machines in factories are instantaneously damaged to stop functioning because of sudden drop of voltage or cutoff without warning in advance, hence resulting in loss of products in the production lines. In order to avoid loss due to bad quality of electric power, independent power supplies (UPS) are built in most factories. Once there is any problem of electric power supply, UPSs are immediately activated. Because a certain period of time is required from the activation of an independent power supply to the supply of the required electric power, there is an idle period of electric power supply. Therefore, the production lines will still have no electric power supply for a short period of time. In order to avoid the occurrence of the above idle period of electric power supply, an UPS is adopted during the idle period of electric power supply from the time when the normal power supply malfunctions to the time when the independent power supply starts to function. Batteries have both the power storage and instantaneous electric discharge functions. Although a single battery cannot store sufficient electric energy for use of machine, if a plurality of batteries are series- or parallel-connected together, the supply of electric energy can be increased. Therefore, a UPS is generally formed with a plurality of batteries series- or parallel-connected together.

There are many important machines operating in a common factory. They are loads to a UPS and will be called load hosts hereinafter. After electric power supply is lost, each load host needs a UPS to provide sufficient electric power. Each UPS comprises a battery set composed of several batteries. The number of battery of the battery set differs according to different electric power requirement of load host or different characteristic of battery. When the electric power supply is normal, the UPS is at a charging state. Once there is an abnormal situation of electric power, the UPS instantaneously changes to a discharging state to provide the required electric power to the load host immediately. Because a load host has its normal working voltage, it is necessary for the battery set of the UPS to provide a sufficiently large voltage to the load host. Because there may be a small number of abnormal batteries in the battery set, more batteries than the number required for the real voltage of the load host are used to enhance the stability of the UPS. Nonetheless, if abnormal batteries are not replaced at the right time, insufficient voltage of the battery set will still arise to be not able to normally provide electric power to the load host.

Generally, abnormal batteries are determined by a too high or too low voltage or a too high or too low temperature during the charging process of battery. Therefore, in order to determine abnormal batteries in real time, it is necessary to continuously detect the voltage and temperature of battery. Much manpower resource and time are required for the conventional artificial measurement method. Presently, a microprocessor matched with a sensor, an analog-to-digital converted (ADC), and so on is commonly used. Matched with use of the above apparatuses, upper and lower limits of temperature or voltage can also be set to detect whether the voltage or temperature exceeds a preset value so as to give out an alarm of abnormal battery to on-the-scene personnel. For instance, a battery set control system disclosed in R. O. C. Pat. No. 437,115 has similar functions of measuring the above battery parameters and alarming.

However, in order to meet requirements of the precision industry, in addition to providing electric power to the load host in a very short time when electric power is cut off, the UPS needs to keep sufficient electric power for a certain period of time. If a battery has a voltage within the safe voltage but has a too large drop rate (dV/dt, V: voltage, t: time) of voltage during discharge, the UPS still cannot keep sufficient electric power supply for a certain period of time. For the requirement of the precision industry, this is also an abnormal state of battery. Although upper and lower limits of voltage and current of battery are measured as the standard for determining the quality of battery, a method of measuring the voltage drop rate of a battery during discharge has not been proposed. Accordingly, the present invention aims to propose an apparatus for detecting batteries in an uninterruptible power supply by utilizing voltage drop rate.

### SUMMARY OF THE INVENTION

The main object of the present invention is to provide an apparatus for detecting batteries in an Uninterruptible Power Supply by utilizing voltage drop.

The second object of the present invention is to provide an apparatus for measuring the drop rate of voltage versus time (dV/dt) of a battery.

Generally, the manufacturers will provide drop rate data of voltage versus time for large-sized batteries. The drop rate curves differ according to different battery types and loads. According to the present invention, after the variation curve is obtained, it is first built in an apparatus whose measurement structure has storing and operation functions (e.g., a computer). When the battery set in the above UPS discharges, the apparatus can be used to record the individual voltage drop value and the corresponding elapsed time. Next, these two kinds of data are inputted into the apparatus having operation function to calculate out the drop rate data of voltage versus time. These data will be compared with the data provided by the manufacturer. When the calculated-out data are lower than 70% of the data provided by the manufacturer, it is determined that replacement of this battery is required, and this battery is replaced with a new one.

The various objects and advantages of the present invention will be more readily understood from the following detailed description when read in conjunction with the appended drawing, in which:

### BRIEF DESCRIPTION OF THE DRAWINGS

FIG. 1 is a structure diagram of the present invention;

FIG. 2 is a table showing the variation of voltage after a brand-new battery is discharged from 2.25V by some constant current for some time; and

FIG. 3 is a voltage drop rate diagram.

### DETAILED DESCRIPTION OF THE PREFERRED EMBODIMENTS

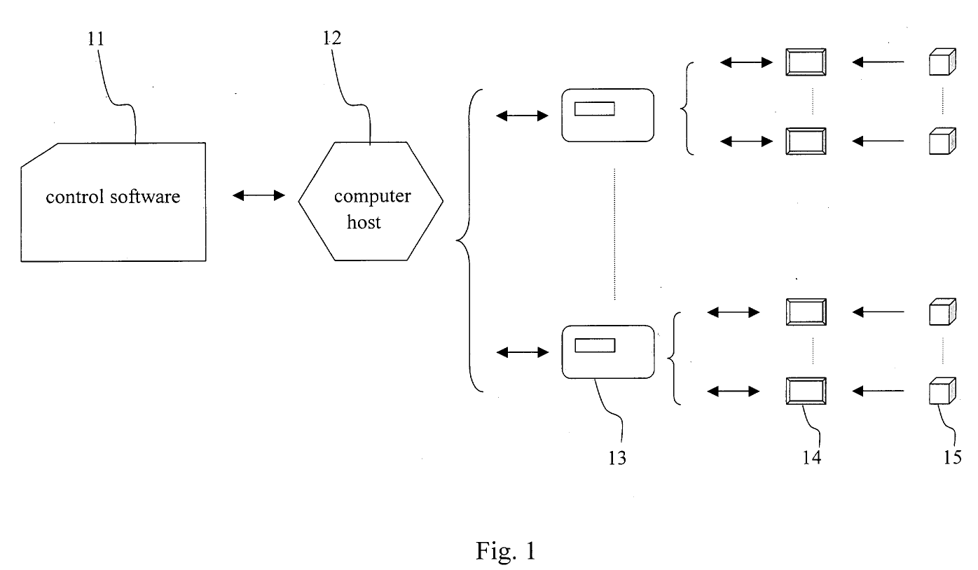

As shown in FIG. 1, the present invention comprises a control software 11, a computer host 12, a plurality of host modules 13, a plurality of parameter measurement modules 14, and a plurality of batteries 15. The control software 11 is provided for setting software and hardware parameters, collecting data, recording data, calculating data, giving out alarms, and performing database inquiry. The host module 13 includes an RS-232 or RS-485 communication interface for collecting parameters from the parameter measurement module 14. The parameters are processed by a microprocessor in the host module 13 and then sent to the computer end. The host module 13 further includes an LCD for displaying presently set alarming parameters and setting the ordinal number of the parameter measurement module 14. A buzzer is also provided to give out alarming sounds. The parameter measurement module 14 uses an analog-to-digital converter to convert the measured temperature and voltage into digital ones, which are encoded by the microprocessor and then sent out via the RS-232 or RS-485 communication interface. The host module and the parameter measurement module are composed of electronic components having the above functions. FIG. 1 shows the connection way of each component. Each of the parameter measurement modules 14 is connected with one of the batteries 15. The parameter measurement module 14 can measure the voltage and temperature of the battery and can keep time. Because a single load host requires more than one battery, different ordinal numbers can be assigned to different batteries in the same battery set of each of the parameter measurement module 14. Each of the host modules 13 can connect several parameter measurement modules 14. The batteries 15 connected to the host module 13 will provide the required electric power for a load host when electric power is cut off. A control display interface in the host module 13 can set the ordinal number, the upper and lower limits of temperature and voltage, and the upper limit of the total voltage of the battery set, and can display the presently measured parameters. Because there are several load hosts in the same factory, several UPS are required. Each UPS calls for a host module for connecting batteries of the system. Therefore, a plurality of host modules are required in the same factory area. The host module can also set the ordinal number to distinguish between host modules at different places. Therefore, the ordinal numbers of the host module and the parameter measurement module are required for discrimination of each battery. The host modules 13 are connected with the computer host 12. In other words, one computer host 12 is connected with several host modules 13. The control software 11 is installed on the host computer 12. The presently connected host modules 13 and parameter measurement modules 14 can be displayed on the screen by means of test connection. All settable parameters on the host modules 13 can be set by the control software 11. The control software 11 can set the time interval for data renewal. That is, it will demand the connected modules to pick the present parameters of batteries every an appropriate period of time. When the action of data renewal occurs, the control software 11 will send out a message of requiring data according to the communication protocol with the host modules 13. Each of the host modules 13 then sends out a message to the connected parameter measurement modules 14 in broadcasting way, thereby providing data of the present battery parameters. After each of the parameter measurement modules 14 connected with the battery 15 receives a message for data renewal, the presently measured voltage and temperature will be immediately converted by the ADC and then transferred to the host module 13. The host module 13 will organize data of all the parameter measurement modules 14 connected therewith and transfer back to the computer host 12. The control software 11 then performs the decoding action. The decoded data will then be displayed on the screen. After data comparison, it is determined whether new data will be stored in a database. When the data is stored, the time will also be recorded. The recorded voltage and the corresponding time during discharge of a battery important data for determining whether there is an abnormal situation. After inquiry of variation of voltage in the database, the variation of voltage versus time (i.e., the drop rate) during discharge of each battery in the factory area can be known through calculation. Discharge voltage and load variation data of normal batteries provided by the manufacturers are built in the control software 11 in advance. Through comparison of the rate of voltage versus time, whether the battery has an abnormal situation can be known. Moreover, the ordinal number of the battery to be replaced is provided to the user for early precaution or replacement, thereby avoiding the situation that the battery set of the UPS cannot provide a normal working voltage to the load host during the next discharge. Therefore, it can be ensured that the UPS can operate normally when electric power is cut off.

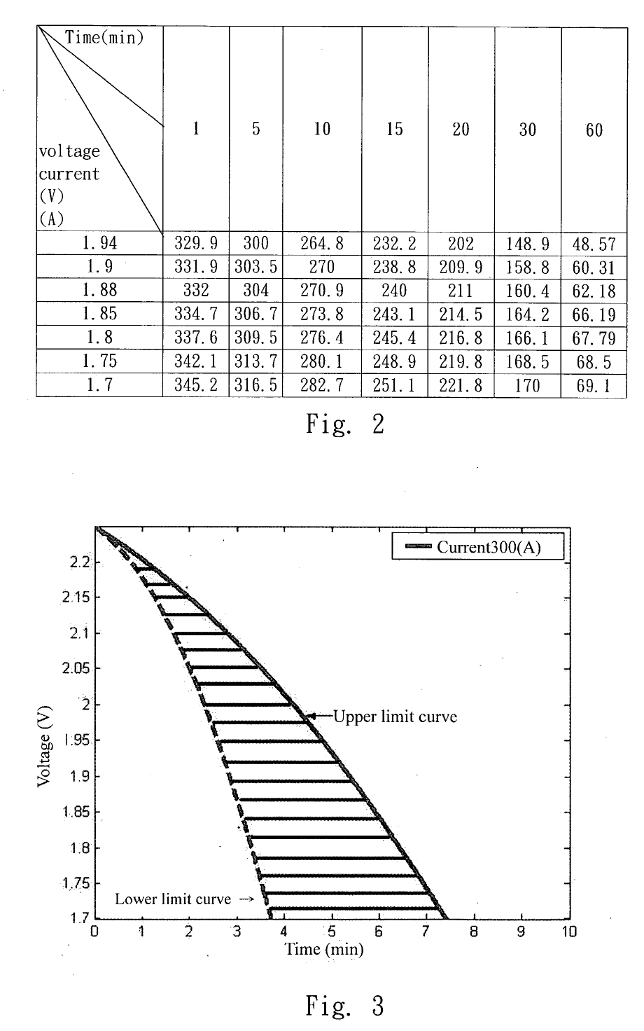

Data in FIG. 2 can be obtained from the manufacturer or can be measured by the user himself for a new battery. The new battery starts to discharge from about 2.25V For instance, if the battery discharges from 2.25V via a current of 300A, the voltage of the battery will drop to 1.94V after 5 minutes.

After the data in FIG. 2 are obtained, the well-known interpolation method can be used to calculate the required time the voltage of 2.25V drops to various voltage values if the load current is 300A. These data are plotted as the solid line (an upper limit curve of voltage drop rate) in FIG. 3. This solid line is an upper limit curve of voltage drop rate of a brand-new battery at a load of 300A. When the battery is used for a period of time or malfunctions, the above voltage drop rate curve will shift leftwards. Therefore, 70% of the upper limit curve (the dashed line in FIG. 3) is set as a lower limit curve of voltage drop rate. When the voltage of a battery is at the left side of the lower limit curve, the battery is no longer applicable to the system and needs to be replaced. If the voltage drop rate curve of a battery is between the solid line and the dashed line, the battery is still usable. Making use of the above voltage drop rate curves, batteries with drawbacks or decaying electric energy can be found in advance to be replaced at the right time, hence ensuring normal operations of a UPS. Similarly, the voltage drop rate curve and the lower limit curve of voltage drop rate required by a system of a brand-new battery at a load of 200A or any other current can be plotted. The above curves can be used to detect the applicability of batteries in the UPS.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An apparatus for detecting batteries in an Uninterruptible Power Supply by utilizing voltage drop, comprising;
a computer host;
a plurality of parameter measurement modules for measuring the variation values of voltage and temperature versus time of a battery;
a control software for setting the software and hard parameters, collecting data, recording data, calculating data, giving out alarms, and performing database inquiry;
a plurality of host modules for collecting said parameters from said plurality of parameter measurement modules; and
a plurality of batteries connected with said plurality of parameter measurement modules.

2. The apparatus of claim 1, wherein said host module further comprises an Rs-232 or RS-485 communication interface.

3. The apparatus of claim 1, wherein said host module further comprises a microprocessor to process said parameters and sent to the computer end.

4. The apparatus of claim 1, wherein said host module further comprises an LCD for displaying presently set alarming parameters and setting the ordinal number of said parameter measurement module.

5. The apparatus of claim 1, wherein said host module further comprises a buzzer for giving out alarming sounds.

6. The apparatus of claim 1, wherein said parameter measurement module uses an analog-to-digital converter to convert the measured temperature and voltage into digital ones.

7. The apparatus of claim 5, wherein said computer host is used to display measurement data of each said host module and calculated the voltage rate cures on said LCD.

8. The apparatus of claim 1, wherein said batteries are lead batteries.

9. The apparatus of claim 1, wherein said batteries are nickel-chromium batteries.

10. The apparatus of claim 1, wherein the voltage rate cures displayed on said LCD comprise the upper limit curves and the lower limit curves, which are obtained through calculating data from said host modules by said computer host so as to determine the applicability of said batteries.
